(19) United States
(12) Patent Application Publication
(10) Pub. No.: US 2013/0046595 A1
(43) Pub. Date: Feb. 21, 2013

(54) System and method for providing location-based time-sensitive deals

(71) Applicants: Bo Wu, Beijing (CN); Yuhong Xiong, Beijing (CN)

(72) Inventors: Bo Wu, Beijing (CN); Yuhong Xiong, Beijing (CN)

(73) Assignee: LaShou Group INC.

(21) Appl. No.: 13/199,076

(22) Filed: Aug. 17, 2011

(51) Int. Cl. G06Q 30/00

(52) U.S. Cl. 705/14.21

(57) ABSTRACT

A system and method of providing online location-based time-sensitive deals are proposed. An online retailer accepts an instant deal submitted by a merchant. The instant deal is a discounted service provided by the merchant at a geographic location. The instant deal is approved only if the merchant is qualified and if the deal is qualified based on a set of pre-configured rules. The online retailer advertises a deal coupon for the discounted service during a limited time for a limited quantity to consumers located near the geographic location. In one example, the geographic location is defined by a business district or a landmark. When a buyer places a purchase order, the deal coupon is delivered to the buyer. The deal coupon is redeemable during a limited time without additional reservation. If the buyer does not redeem the coupon within the limited time, the purchase amount is automatically refunded.

### TECHNICAL FIELD

The present invention relates generally to e-commerce and, more particularly, to system and method for online services providing discounted location-based and time-sensitive deals.

### BACKGROUND

Group buying, also known as collective buying, offers products and services at significantly reduced prices on the condition that a minimum number of buyers would make the purchase. Origins of group buying can be traced to China where Tuángòu or team buying was executed to get discount prices from a retailer when a large group of people was willing to buy at the same item. In recent time, Group-buying websites have emerged as a major player in online shopping business. Typically, these websites feature a deal of the day, with the deal kicking in once a set number of people agree to buy the product or service. Buyers then print off a voucher to claim their discount at the retailer. Many of the group-buying sites work by negotiating deals with local merchants and promising to deliver crowds in exchange for discounts. Group-buying sites are now in demand as small businesses look for ways to promote their products to budget-conscious consumers in a weak global economy.

Under Tuángòu, an item must be bought in a minimum quantity or dollar amount; otherwise the seller will not allow the purchase. Since individuals typically do not need multiples of one item or do not have the resources to buy in bulk, group buys allow people to invite others to purchase in bulk jointly. These group buys often result in better prices for the individual buyers or ensure that a scarce or obscure item is available for sale. If visitors or subscribers to a discount website are tempted by a discount offer, they enter their payment details online and wait. Once a minimum number of people sign up for the same offer, the deal is confirmed and a voucher or SMS is sent to their inboxes. Though shops, restaurants, and other retailers that partner with these discount websites have to take hefty price cuts, they have gained access to a whole new group of customers.

The group-buying model reduces risk for retailers, who can treat the coupons as quantity discounts as well as sales promotion tools. However, there are potential problems associated with such business model. For example, a successful deal could temporarily swamp a small business with too many customers, risking a possibility that customers will be unsatisfied, or that there won't be enough product to meet the demand. On the other hand, frequently unsuccessful deals may result in negative experiences for the consumers, who are not able to get the discount product or service as they hoped for. Moreover, as e-commerce becomes more popular in fast-paced modern days, instant online deals are becoming more attractive to consumers. More and more retailers thus are providing instant online deals to attract consumers via various group-buying companies. Consumers, however, may face the problem of being flooded by emails, text messages, and popup windows for un-wanted or non-interested advertisements provided by the group-buying companies. Solutions are sought to more effectively advertise instant online deals to attract the right consumer for the right deal.

### SUMMARY

A system and method of providing online location-based time-sensitive deals are proposed. An online retailer accepts an instant deal submitted by a merchant. The instant deal is a discounted service provided by the merchant at a geographic location. The instant deal is approved only if the merchant is qualified and if the deal is qualified based on a set of pre-configured rules. The online retailer advertises a deal coupon for the discounted service during a limited time for a limited quantity to consumers located near the geographic location. When a buyer places a purchase order, the deal coupon is delivered to the buyer. The deal coupon is redeemable during a limited time without additional reservation. If the buyer does not redeem the coupon within the limited time, the purchase amount is automatically refunded.

In one novel aspect, the geographic location is defined by a business district or a landmark. The online retailer advertises (e.g., via email, advertising banner, popup window, short message service (SMS), or alert text message) the instant deal to potential customers that are located within the business district. In one example, the deal is an instant lunch deal. Because a customer's work location is usually associated with a business district, the customer can easily find instant lunch deals near their workplace. For example, a deal coupon is sent to a mobile device (e.g., mobile phones, PDAs) carried by the consumer, and the location of the mobile device is used to determine which deal coupon to advertise.

In one embodiment, a fast deal submission and approval system is used to approve each instant deal. Before a deal is listed and advertised to the consumer, the online retailer verifies that the merchant has a good reputation (merchant qualification) and the submitted deal is good (deal qualification). In one example, the online retailer stores information of all services provided by all the merchants in a database such that deal qualification can be done based on a set of pre-configured rules as soon as a deal is submitted.

In another embodiment, in addition to location-based instant deal advertisement, personalized deal advertisement is used to target and attract potential buyers. In one example, the online retailer stores a user profile in a database. The user profile contains a list of user information including name, age, gender, preference, and behavior. Based on the user information, the online retailer can selectively advertise a particular online deal to a group of customers that most likely have a high interest to the deal.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a location-based instant deal system in accordance with one novel aspect.

FIG. 2 is a detailed online retail procedure using a novel location-based instant deal system.

FIG. 3 illustrates a novel location-based and personalized instant deal advertisement mechanism provided by an online retailer.

FIG. 4 is a flow chart of one embodiment of providing a location-based and time-sensitive deal in accordance with one novel aspect.

FIG. 5 is a flow chart of one embodiment of receiving a location-based and time-sensitive deal in accordance with one novel aspect.

### DETAILED DESCRIPTION

Reference will now be made in detail to some embodiments of the invention, examples of which are illustrated in the accompanying drawings.

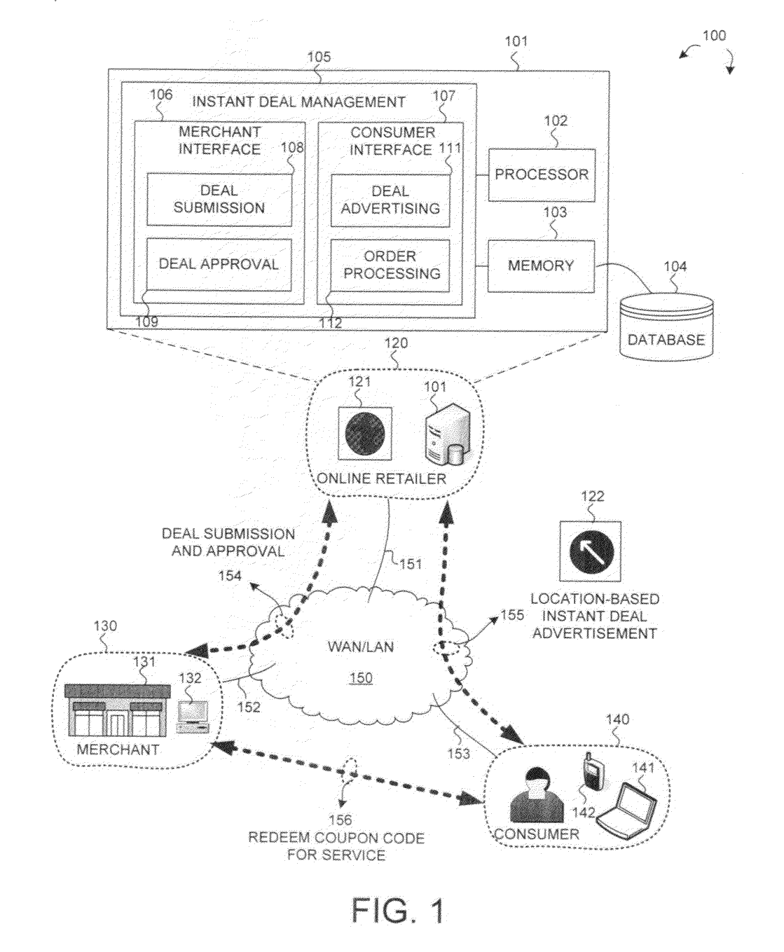

FIG. 1 illustrates a location-based instant deal system 100 in accordance with one novel aspect. Location-based instant deal system 100 comprises an online retailer 120, a plurality of merchants (e.g., merchant 130 as illustrated in FIG. 1), and a plurality of consumers (e.g., consumer 140 as illustrated in FIG. 1). Online retailer 120 is an online seller that sells discounted products and services to large groups of consumers for sales campaigns made in a short duration of time via various discounted websites (e.g., website 121). For example, online retailer 120 uses a server computer 101 to implement a particular instant deal sales campaign. Merchant 130 is a supplier that supplies the discount products or services to consumers via online retailer 120. In one example, merchant 130 is a service provider that provides various services such as dining, lodging, or other entertaining activities at location 131. In another example, merchant 130 uses a client computer 132 to facilitate the communication with online retailer 120 via server computer 101. Consumer 140 is a customer that purchases the discounted products or services from online retailer 120. For example, consumer 140 uses either a laptop client computer 141 or a mobile device (e.g., a mobile phone, or a personal digital assistant (PDA), etc.) 142 to browse the Internet and receive online deals via webpage 122 for products and/or services advertised by online retailer 120.

In the example of FIG. 1, online retailer 120 utilizes server computer 101 to provide location-based and time-sensitive deals for discounted services provided by merchant 130. Server computer 101 comprises a processor 102, memory 103 coupled to a permanent database 104, and an instant deal management module 105 comprising a merchant interface 106 and a consumer interface 107. Merchant interface 106 comprises a deal submission module 108 and a deal approval module 109. Deal submission module 108 facilitates the reception mechanism of various instant online deals submitted by merchant 130 (e.g., by email exchanges). Deal approval module 109 facilitates the approval mechanism of the various instant online deals submitted by merchant 130 (e.g., by a set of pre-configured rules). Consumer interface 107 comprises a deal-advertising module 111 and an order-processing module 112. Deal-advertising module 111 advertises the location-based instant online deals to the consumers. Order-processing module 112 receives and processes purchase orders for the deals from the consumers.

The different modules within instant deal management module 105 are function modules that may be running on the same or different computer servers. The function modules, when executed by processor 102, allow online retailer 120 to receive and evaluate the instant deals submitted by merchant 130, and to advertise and provide the approved instant deals to consumers via communication between server computer 101 and other client computers. In one embodiment, various activities are performed by exchanging communication messages in location-based instant deal system 100 via WAN/LAN 150 (e.g., the computers are connected to WAN/LAN 150 via wired or wireless links 151, 152, and 153 respectively). In a first example, online retailer 120 may accept or reject instant deals submitted by merchant 130 via email exchanges between server computer 101 and client computer 132 (e.g., depicted by a thick dashed-line 154). In a second example, online retailer 120 advertises location-based instant deals and delivers a coupon code to client computer 141 and/or mobile phone 142 for the sold service (e.g., depicted by a thick dashed-line 155). In a third example, consumer 140 redeems the coupon code for the purchased service under instructions provided by merchant 130 (e.g., depicted by a thick dashed-line 156). All the activities performed by the different parties—and all the information created and updated related to all the business transactions—are saved by server computer 101 onto DB104.

In one novel aspect, online retailer 120 provides location-based instant deals to consumers in location-based instant deal system 100. Instant deals are time-sensitive deals for services offered by local merchants at deep discounted prices, during limited time, and with limited quantity. Location-based instant deals are in general designed to attract local consumers for local services provided by local merchants. For example, an instant deal for a business lunch/dinner, an afternoon tea, a spa/message service, a wedding photo service, or a hotel service may attract consumers that are located very close to the geographic location of the services because of the deeply discounted price and the convenient location. In one embodiment, online retailer 120 provides a fast deal submission and approval mechanism to receive and evaluate various instant deals for discounted services provided by the local merchants. In another embodiment, online retailer 120 advertises the approved instant deals to targeted consumers via effective location-based advertisements. The instant deals are personalized based on user behavior/preference to further improve advertising effectiveness and to reduce online traffic flooding. Different embodiments and procedure of the location-based instant deal system are provided below.

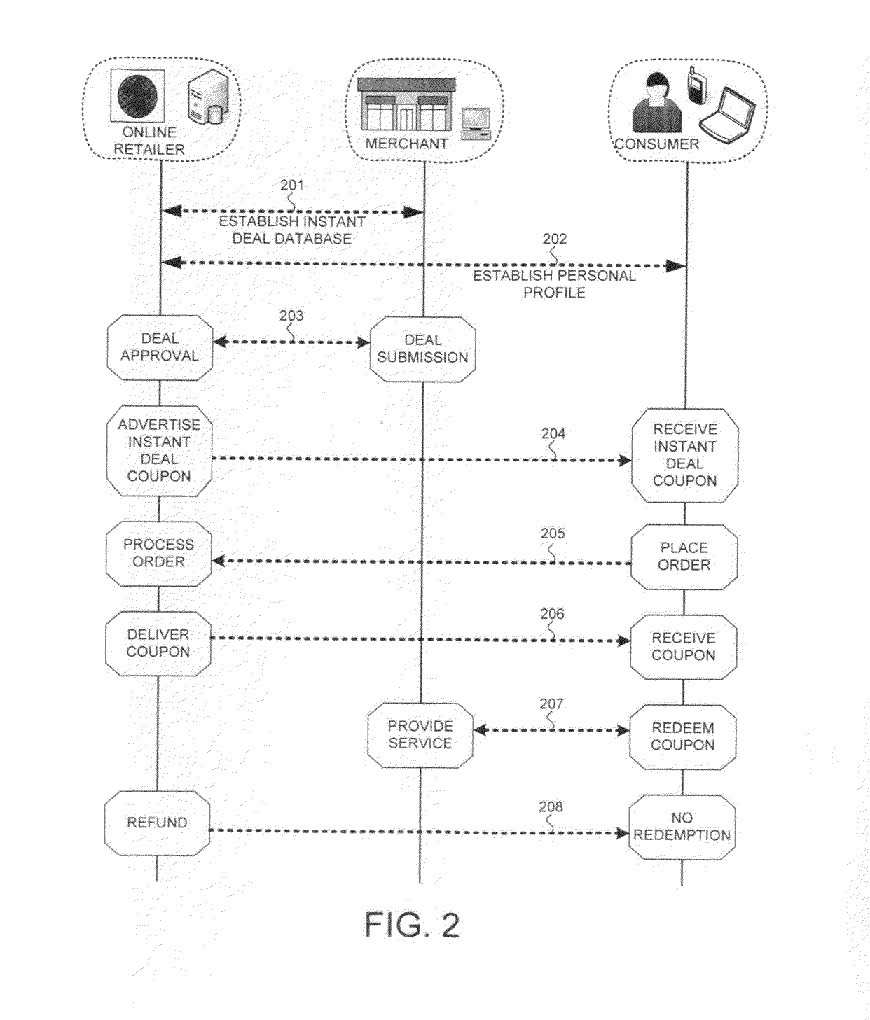

FIG. 2 is a detailed online retail procedure using a novel location-based instant deal system. In step 201, an online retailer establishes an instant deal database to facilitate a fast deal submission and approval mechanism. The instant deal database may include a list of qualified local merchants and lists of provided services. In step 202, the online retailer establishes a personal profile database for all members/users of the online retailer. The personal profile database may include basic information of the members/users and their buying behavior/preference. In step 203, a merchant submits an instant deal, which is approved by the online retailer. In step 204, the online retailer advertises the approved instant deal via a server computer, where potential buyers or subscribed members can receive the advertised instant deal via a client computer. In step 205, a buyer places a purchase order, and the server computer receives and processes the purchase order. In step 206, the buyer receives a voucher or a coupon code delivered by the online retailer. Before the specified expiration time, the buyer redeems the coupon, and the merchant validates the coupon and provides the service in step 207. Alternatively, if the buyer does not redeem the coupon within the specified time duration, the online retailer automatically refunds the purchased amount to the buyer's account in step 208.

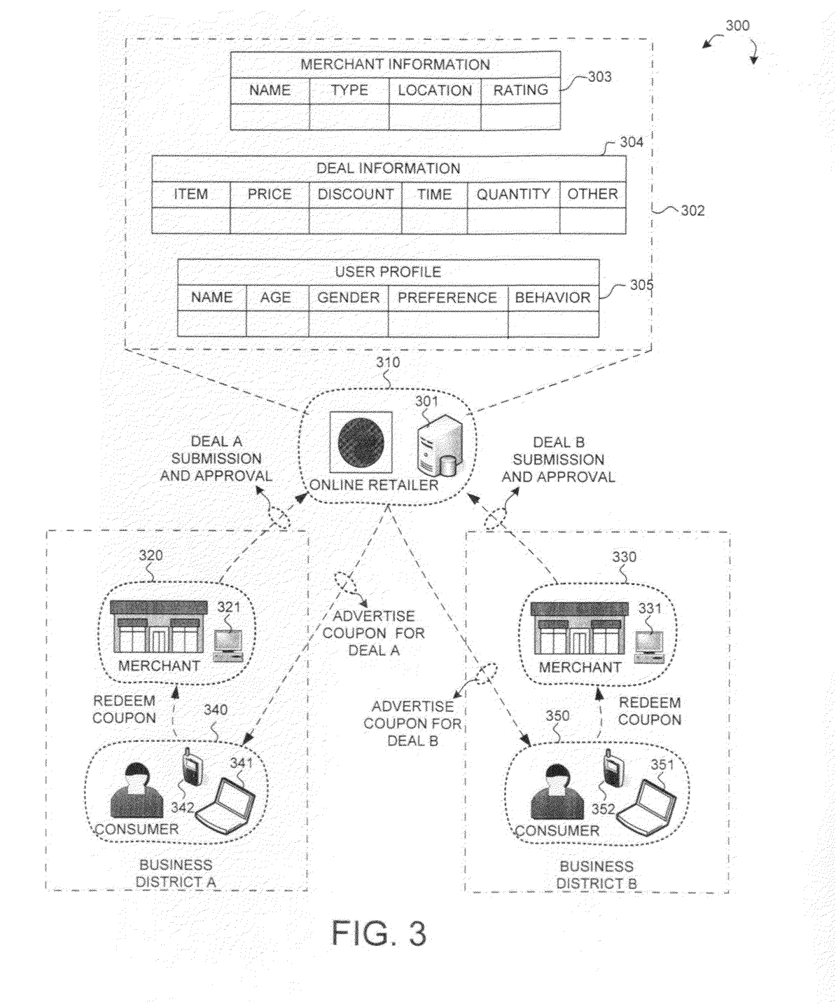

FIG. 3 illustrates one embodiment of a novel location-based instant deal system 300 with fast deal submission and approval mechanism. Location-based instant deal system 300 comprises an online retailer 310, a first local merchant 320, a second local merchant 330, a first consumer 340, and a second consumer 350. The first local merchant 320 is located in a business district A and provides an instant deal A through online retailer 310, while the second local merchant 330 is located in another business district B and provides an instant deal B also through online retailer 310. Similarly, the first consumer 340 is located in business district A and is a subscribed customer of online retailer 310, while the second consumer 350 is located in business district B and is also a subscribed customer of online retailer 310. Online retailer 310 provides a fast deal submission and approval mechanism to both merchants 320 and 330, as well as a location-based and personalized instant deal advertisement mechanism to its customers via server computer 301 that contains database 302.

As illustrated in FIG. 3, database 302 comprises a merchant information table 303, a deal information table 304, and a user profile table 305. For each instant deal submitted by a merchant, the online retailer must first verify that the merchant is good (e.g., merchant qualification) and that the deal is good (e.g., deal qualification). For merchant qualification, the online retailer may evaluate the reputation of each merchant beforehand. In addition, the merchant information table 303 may be used to facilitate the qualification process. Merchant information table 303 contains a list of name, service type, service location, and overall rating based on user review for each merchant. For example, if the rating of a merchant is higher than a pre-configured threshold, then the merchant is qualified. Otherwise, the merchant is not qualified. For deal qualification, the online retailer may evaluate each instant deal based on deal information table 304. Deal information table contains a list of service (e.g., item) name, original price, discount price, offered time duration, offered quantity, and other information for each instant deal submitted from each merchant. A set of pre-configured rules may then be used to determine whether a submitted deal is qualified. For example, one rule is that the discount must be at least fifty percent: Because the original price of all the items are already stored in deal information table 304, a newly submitted instant deal with the discounted price can be verified immediately based on deal information table 304. In addition, other information—such as past reviews, comments, and feedbacks for a particular deal item from consumers—may be used as references for a buyer to make a purchase decision.

Once an instant deal is submitted and approved, the online retailer advertises the instant deal to all potential buyers that are most likely to be interested in the deal. Because an instant deal is typically for a discounted service provided in a particular geographic location during a specified limited time period, consumers located near the geographic location would be mostly interested in the deal. On the other hand, consumers located far away from the geographic location would likely not be as interested in the deal. Therefore, based on the geographic location of the instant deal, and based on the current location of the customer, the online retailer only advertises the instant deal to consumers who are located near the geographic location of the instant deal. In the example of FIG. 3, because merchant 320 offers deal A at a location in business district A, online retailer 310 advertises a deal coupon for deal A to consumer 340 that is located within the same business district A. Similarly, because merchant 330 offers deal B at a location in business district B, online retailer 310 advertises a deal coupon for deal B to consumer 350 that is located within the same business district B.

Because an instant deal is typically only available for a very short period of time (e.g., a few hours), the concept of geographic location is not associated with an area as big as a city, a town, or even an area specified by a zip code. Instead, the concept of geographic location is associated with a much smaller area such as a business district (e.g., the financial district of downtown San Francisco) or a landmark (e.g., Pier 39 in San Francisco). For example, if an instant deal for a business lunch meal is offered during lunch hour (e.g., from 12:30 to 3:00 pm) at a restaurant, then only consumers located within the walking distance of the restaurant would be interested in purchasing the deal immediately before lunch time.

In contrast to traditional group-buying services that require a minimum number of sales to justify volume discount, the instant deals do not require any minimum number of sales. On the contrary, only a very limited number of the service items are provided for each instant deal, and the deal is valid as soon as a consumer makes the purchase, without additional confirmation requirement. The time and quantity of the deal are completely controlled by each merchant. This ensures that the merchant will not be swamped by too many consumers, and that the deal makes financial sense with the deep discount (e.g., as a viable promotion tool).

In addition to location-based advertising, personalized deal advertisement technique may also be used to target potential buyers. For customers that are subscribed members of online retailer 310, user profile table 305 may be created and used (e.g., via server computer 301) to implement a personalized deal advertisement. User profile table 304 contains a list of user information including name, age, gender, preference, and behavior. For example, each subscribed member provides his/her personal information such as name, age, gender when creating his/her personal account with online retailer 310. Each subscribed member may also provide any personal buying preference (e.g., interested in certain types of service including dining, lodging, sports, health, travel) and other personal information (e.g., marital status, educational background, profession, income level) via various surveys provided by online retailer 310. Furthermore, online retailer 310 may monitor each member's buying behavior based on past buying/browsing records (e.g., interested in travel). All the information is then collectively used to build user profile table 304. Based on user profile table 304, online retailer 310 can selectively advertise a particular online deal to a group of customers that most likely has a high interest in the deal. For other customers that may not be interested in such deal, no advertisement (e.g., emails or text messages) will be sent to them.

On the other hand, if a user browses the internet without logging in to his/her account, or if a user is not a subscribed member of online retailer 310, other more generic-targeting advertisement techniques may be used. In one example, because most instant deals are time-sensitive (e.g., an instant lunch deal from 12:30 to 3:00 pm), a popup window advertising the instant lunch deal will appear on a user's computer or phone screen during the 12:00 to 1:00 pm timeframe when the user is browsing a discount website of online retailer 310. In another example, cookies (e.g., also known as HTTP, web, or browser cookies) may be used to track the user's browsing activities. Based on the past browsing behavior of users, online retailer 310 may selectively advertise deals to customers who have the most buying potential.

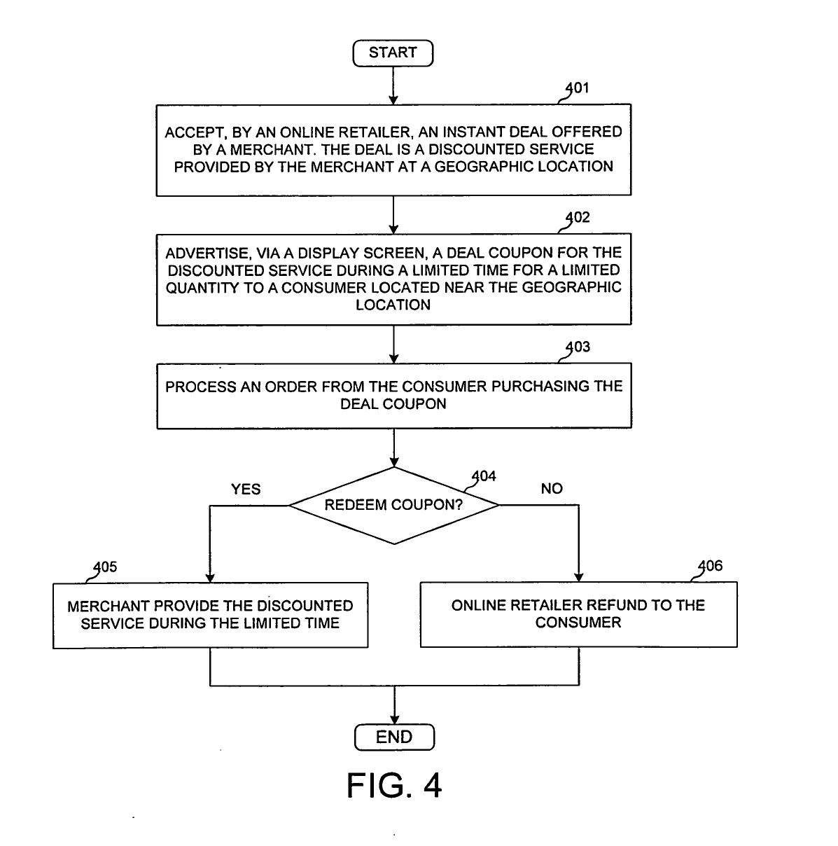

FIG. 4 is a flow chart of a first embodiment of a method of providing location-based and time-sensitive deals. In step 401, an online retailer accepts an instant deal offered by a local merchant. The instant deal is a service provided by the local merchant at a geographic location. The deal is offered at a deeply discounted price, during a limited amount of time, and with a limited quantity of service items. In step 402, the online retailer advertises the instant deal to customers located near the geographic location. In a pull method, a user needs to proactively go to a website of the online retailer to see the available deals. In a push method, deals automatically pop up on a user's computer or phone screen. Other advertising means include emails, banners, and short messages or alert messages for smart phone apps. The user can control the push by configuring the frequency of popup, types of services, and other factors. In step 403, a buyer places an order for the deal and the online retailer processes the order and delivers a deal coupon to the buyer. The deal coupon is only valid for a limited time duration for the instant deal. In step 404, the buyer determines whether to redeem the deal coupon within the specified time duration. If yes, the merchant provides the discounted service for the buyer in step 405. If no, the online retailer refunds the purchased amount to the buyer's account in step 406.

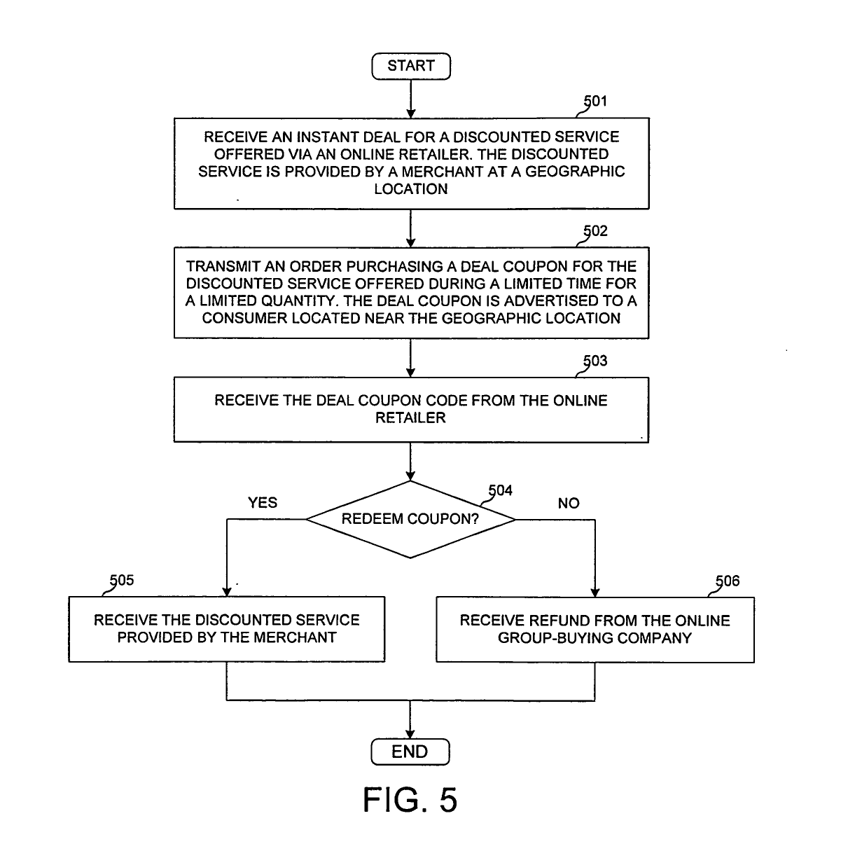

FIG. 5 is a flow chart of a second embodiment of a method of providing location-based and time-sensitive deals. In step 501, a user receives an instant deal advertisement for a discounted service offered by an online retailer. In step 502, the user sends an order purchasing the discounted service. The discounted service is provided by a local merchant at a geographic location, during a limited amount of time, and with a limited quantity of supply. In step 503, the user receives a deal coupon from the online retailer. In step 504, the user determines whether to redeem the deal coupon within the specified time duration. If yes, the user receives the service provided by the merchant in step 505. If no, the user receives the refund from the online retailer in step 506.

In one specific embodiment, the user carries a mobile phone that installs a client application for the instant deal services provided by the online retailer. Each mobile phone has its geographic location information provided via global positioning system (GPS) or via communication with a base station tower. The installed client application interacts with the server application running on a server computer of the online retailer. Based on the location of the mobile phone, the mobile phone will receive instant deals that are offered near its location. For example, an instant lunch deal is offered by a restaurant in a downtown business district during 12:30 to 3:00 pm on a certain day. When the customer is located within the walking distance of the downtown business district on that day at noon time, an advertisement of the instant lunch deal will pop up on the mobile phone of the customer. The customer is very likely to be interested in having the lunch deal because it is offered at the right time, the right location, and the discounted price. In one embodiment, the server application will filter all the deals and only send the most attractive deals to the customer. In another embodiment, the server application sends out all the deals to the client application, and the client application filters out non-interested deals and only displays deals based on the location and other user-configured information such as preferred service types.

The location-based and time-sensitive deals are applicable in many different types of services. In addition to food-related services such as the instant lunch/dinner/afternoon-tea deals described above, location-based daily hotel deals can also be provided via online retailers. Different from typical hotel deals, location-based daily hotel deals are targeted to local customers instead of to travelers. There are two main purposes for locals to stay in a hotel: one is for entertainment, and the other is to stay overnight near a workplace to avoid a long commute. For entertainment-related deals, a hotel room is usually bundled with other services such as spa, breakfast-in-bed, workout package, etc. The daily hotel deals are available in the late afternoon or early evening—and only available for a few hours with very limited number of rooms. Because the deals carry a deep discount, they are likely to be sold out quickly, even within a few seconds. The hotels are categorized by locations such as business district or landmarks, so that customers can easily find deals near their preferred location.

In one or more exemplary embodiments, the functions described above may be implemented in hardware, software, firmware, or any combination thereof. If implemented in software, the functions may be stored on or transmitted over as one or more instructions or code on a computer-readable (processor-readable) medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that both can be used to carry or store desired program code in the form of instructions or data structures, and can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A computer-implemented method, comprising:
accepting an instant deal offered by a merchant, wherein the instant deal is a discounted service provided by the merchant at a geographic location;
advertising, via a display screen, a deal coupon for the discounted service during a limited time for a limited quantity to a consumer located near the geographic location; and
processing an order from the consumer purchasing the deal coupon, wherein the deal coupon is redeemable during the limited time.

2. The method of claim 1, wherein the instant deal is categorized by geographic location defined by a business district or a landmark, and wherein the deal coupon is not advertised to consumers located outside the geographic location.

3. The method of claim 1, wherein the instant deal is accepted if the merchant is a qualified merchant and if the instant deal is a qualified deal based on a set of pre-configured rules.

4. The method of claim 1, wherein the deal coupon is advertised via the display screen in a form of an email, an advertising banner, a popup window, a short message service (SMS), or an alert text message.

5. The method of claim 1, wherein the deal coupon is sent to a mobile device carried by the consumer, and wherein the location of the mobile device is used to determine which deal coupon to advertise.

6. The method of claim 1, wherein the deal coupon is advertised based on personalized information of the consumer.

7. The method of claim 6, wherein personalized information comprises age, gender, buying history, browsing history, or preference of the consumer.

8. A server system, comprising:
a deal-approval module that accepts an instant deal offered by a merchant, wherein the instant deal is a discounted service provided by the merchant at a specific geographic location;
a deal-advertising module that advertises a deal coupon for the discounted service during a limited time for a limited quantity to a consumer located near the geographic location; and
an order-processing module that processes an order from the consumer purchasing the deal coupon, wherein the deal coupon is redeemable during the limited time.

9. The system of claim 8, wherein the instant deal is categorized by geographic location defined by a business district or a landmark, and wherein the deal coupon is not advertised to consumers located outside the geographic location.

10. The system of claim 8, wherein the instant deal is accepted if the merchant is a qualified merchant and if the instant deal is a qualified deal based on a set of pre-configured rules.

11. The system of claim 8, wherein the deal coupon is advertised via a display screen in a form of an email, an advertising banner, a popup window, a short message service (SMS), or an alert text message.

12. The system of claim 8, wherein the deal coupon is sent to a mobile device carried by the consumer, and wherein the location of the mobile device is used to determine which deal coupon to advertise.

13. The system of claim 8, wherein the deal coupon is advertised based on personalized information of the consumer.

14. The system of claim 13, wherein personalized information comprises age, gender, buying history, browsing history, or preference of the consumer.

15. A method, comprising:
receiving an instant deal for a discounted service offered via an online retailer, wherein the discounted service is provided by a merchant at a geographic location;
transmitting an order purchasing a deal coupon for the discounted service offered during a limited time for a limited quantity, wherein the deal coupon is advertised to a consumer located near the geographic location; and
redeeming the deal coupon during the limited time without additional reservation for the discounted service.

16. The method of claim 15, wherein the instant deal is categorized by geographic location defined by a business district or a landmark, and wherein the deal coupon is not advertised to consumers located outside the geographic location.

17. The method of claim 15, wherein the deal coupon is advertised via a display screen in a form of an email, an advertising banner, a popup window, a short message service (SMS), or an alert text message.

18. The method of claim 15, wherein the deal coupon is sent to a mobile device carried by the consumer, and wherein the location of the mobile device is used to determine which deal coupon to advertise.

19. The method of claim 15, wherein the deal coupon is advertised based on personalized information of the consumer.

20. The method of claim 19, wherein personalized information comprises age, gender, buying history, browsing history, or preference of the consumer.
